(19) United States
(12) Patent Application Publication
(10) Pub. No.: US 2007/0144068 A1
(43) Pub. Date: Jun. 28, 2007

(54) Sprouts and baby leaf crops farming device

(76) Inventor: Chin-Hsing Feng, Taoyuan County (TW)

Correspondence Address: Chin-Hsing Feng, P.O. Box 44-2049, Taipei, 10668, TW

(21) Appl. No.: 11/318,856

(22) Filed: Dec. 28, 2005

(51) Int. Cl. A01G 31/00

(52) U.S. Cl. 47/60

(57) ABSTRACT

A farming device includes a base having a plurality of lattices and each of the lattices is connected with a support member so as to receive at least one seed therein. A nutrient pad is located beneath the support members so as to provide water and necessary elements to the seeds. A guiding plate is located on the base and has a plurality of recesses so that the sprouts extend through the recesses. A dynamic cutter is movably located on the guiding plate and has a plurality of cutting notches which cuts the roots of the plants when pulling the dynamic cutter from the base. A static cutter is located on the dynamic cutter. A cover receives the base, the guiding plate, the dynamic cutter and the static cutter therein.

### BACKGROUND OF THE INVENTION

(1) Field of the Invention

The present invention relates to a device for organizing the direction of the sprouts and baby leaf crops for easily removing the roots from the plants.

(2) Description of the Prior Arts

Vegetables are important for people to maintain a healthy condition. There are so many types of plants are proved to benefit to out bodies, such as wheatgrass, alfalfa sprouts, sunflower sprouts, pea sprouts, buckwheat sprouts, mung bean sprouts, and fenugreek sprouts. All of the sprouts of the plants have plenty of vitamin A, B, C, E, K, calcium, iron and/or even protein. In order to obtain a mass production for growing clean sprouts of these plants, hydroponic farming is a good method to grow the plants by floating the plants in a nutrient tanks which are shallow and occupy less space when compared with the conventional way to farm the plants.

However, when spreading the seedlings on the trays the seedling randomly drop on the nutrient surface of the trays, a certain amount of the seedlings are oriented up-side-down so that the direction of the sprouts cannot be well organized and are easily damaged when overlapping the trays. Besides, when removing the roots of the plants, due to the random growing of the sprouts, the roots cannot be cut within single cutting steps and the farmers have to spent more time on removing the roots, especially for the sprouts in wrong directions. Furthermore, the randomly arrangement sprouts are difficult to be packed by packages.

The present invention intends to provide a device for organizing the sprouts and baby leaf crops and the device include a cutting tray which can easily cut the roots from the sprouts in one step.

### SUMMARY OF THE INVENTION

The present invention relates to a sprouts and baby leaf crops farming device which comprises a base having crosswise rails so as to define a plurality of lattices and each of the lattices has a support member located therebeneath and each support member has openings. A nutrient pad is located beneath the support members. A guiding plate is located on the base and has a plurality of recesses which are located corresponding to the lattices. A dynamic cutter is movably located on the guiding plate and has a plurality of cutting notches which are located corresponding to the recesses. A static cutter is located on the dynamic cutter and has a plurality of shear edges which are located corresponding to the cutting notches. A cover has a hollow interior to receive the base, the guiding plate, the dynamic cutter and the static cutter.

The primary object of the present invention is to provide a device for guiding the seedlings to grow in a desired direction and the roots of the plants can be easily cut by pulling a dynamic cutter from the device. The device can be easily used in a mass production arrangement.

The seedlings are well organized in the lattices of the device so that maximum number of the seedlings can be planted in the device. The seedlings are organized so that there will be no damage to the sprouts. The sprouts and the baby leaf crops are not yet cut and the roots are well maintained when the sprouts and the baby leaf crops are sent to the customers so that the fresh period can last longer. The device involves different stages of farming, growing, transportation and selling to the customers of the sprouts and the baby leaf crops so that unnecessary processes and packing material can be saved. The customers can easily cut all the roots by pulling the dynamic cutter so that the customers get the sprouts and/or the baby leaf crops fresh.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the device of the present invention;

FIG. 2 shows that the guiding plate is overlapped on the base;

FIG. 3 shows that the dynamic cutter is overlapped on the guiding plate;

FIG. 4 shows that the static cutter is overlapped on the dynamic cutter;

FIG. 5 shows all of the plates are received in a cover;

FIG. 6 shows the sprout begins to grow in the device;

FIG. 7 shows the sprout is guided by the skin filters;

FIG. 8 shows the skin of the seed is removed from the sprout;

FIG. 9 shows the handle of the dynamic cutter is pulled;

FIG. 10 shows the roots of the sprouts are cut by pulling the dynamic cutter;

FIG. 11 shows that the sprout is located between the cutting notches and shear edge;

FIG. 12 shows that the devices are used in a first arrangement;

FIG. 13 shows that the devices are used in a second arrangement;

FIG. 14 shows another embodiment of the skin filters;

FIG. 15 shows the lattices are elongate slots and skin filters located on two sides of the elongate slots, and

FIG. 16 shows another embodiment of the device of the present invention.

### DETAILED DESCRIPTION OF THE PREFERRED EMBODIMENTS

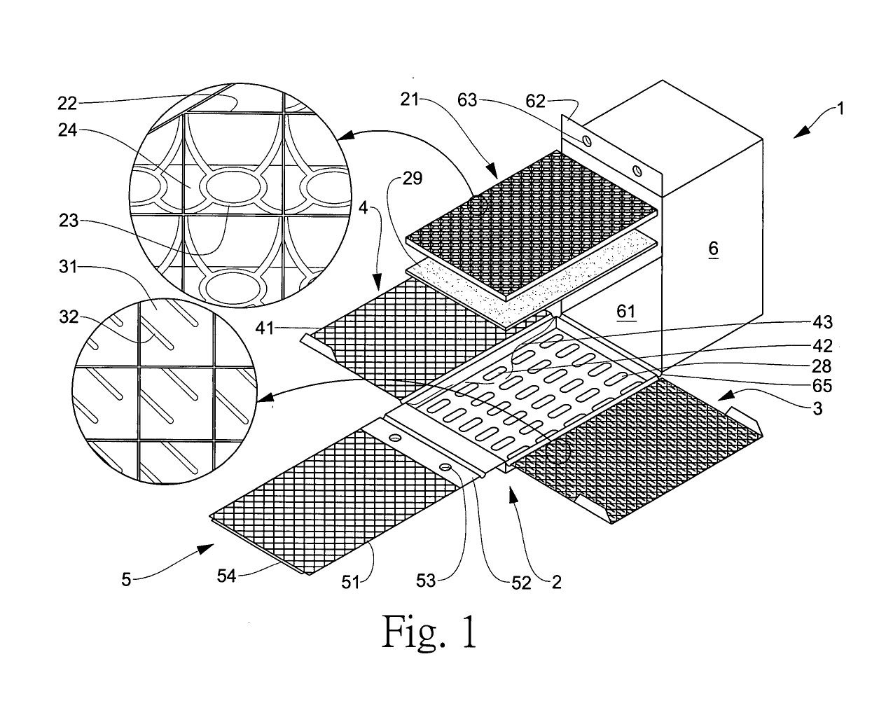

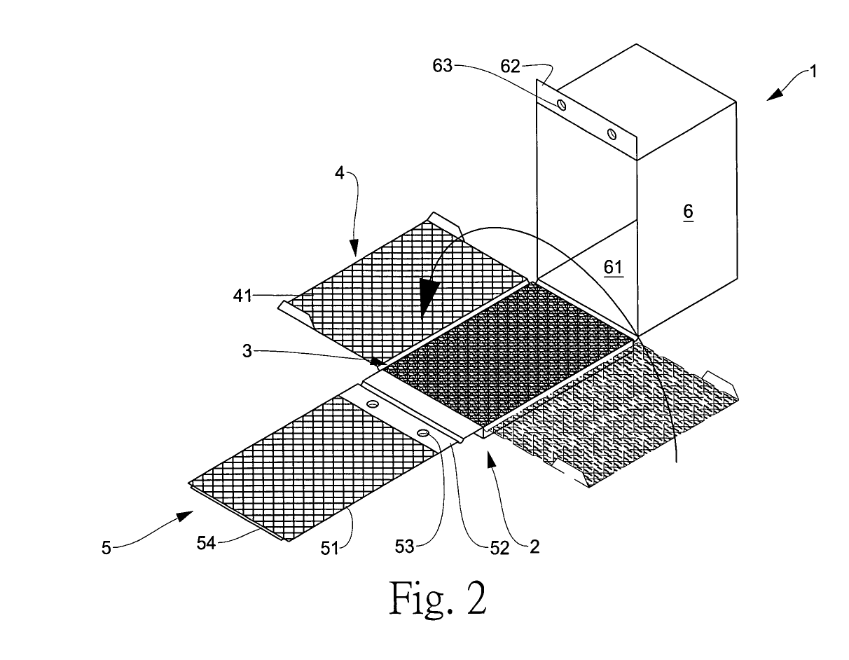

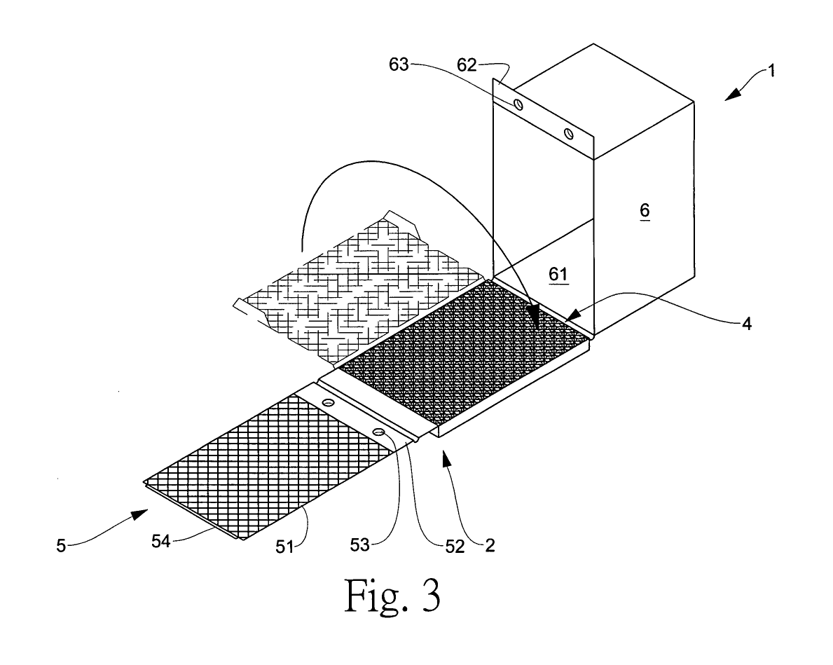

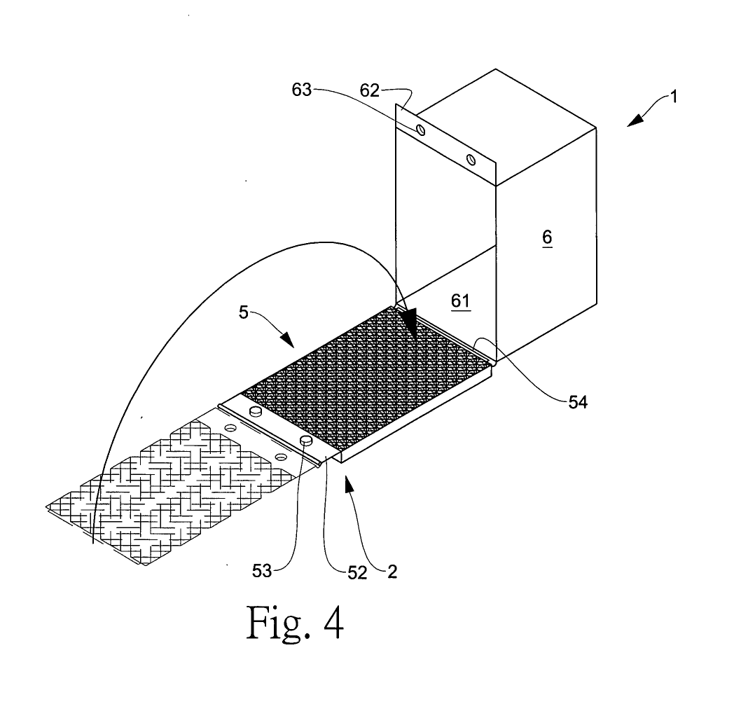

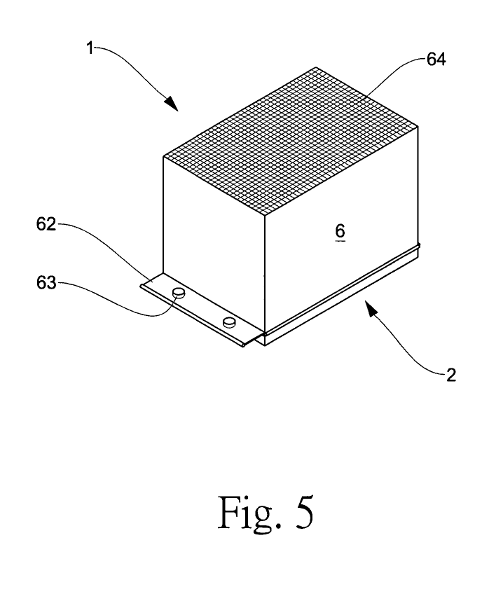

Referring to FIGS. 1 to 5, the device 1 for farming sprouts and baby leaf crops of the present invention comprises a base 2 which has crosswise rails 21 so as to define a plurality of lattices 22 between the rails 21. The base 2 has an open bottom 28 and each of the lattices 22 has a support member 23 located therebeneath and each support member 23 includes a recessed packet which includes a lowest area so that the seeds 7 are ensured to be located at a center of the pockets. Openings 24 are defined in the support members 23. A nutrient pad 29 made by non-woven fabrics, cottons or any known material that absorbs liquid such as water and nutrients therein, is located beneath the support members 23 so that the water and nutrients can be supplied to the seeds 7 via the openings 24.

A guiding plate 3 is connected to a side of the base 2 and can be pivoted to overlap on the base 2. The guiding plate 3 has a plurality of recesses 31 which are located corresponding to the lattices 22. Each of the recesses 31 has a plurality of skin filters 32 located at a pitch therebetween.

A dynamic cutter 4 is connected to the other side of the base 2 which is located between the guiding plate 3 and the dynamic cutter 4. The dynamic cutter 4 can be pivoted on the guiding plate 3 and has a plurality of cutting notches 41 which are located corresponding to the recesses 31.

A static cutter 5 is connected to a third side of the base 2 by a first connection plate 52 located between the base 2 and the static cutter 5. The connection plate 52 includes a plurality of connection pieces 53. The static cutter 5 can be pivoted to overlap on the dynamic cutter 4 and has a plurality of shear edges 51 which are located corresponding to the cutting notches 41. The recesses 31, the cutting notches 41 and the shear edges 51 can be rectangle-shaped.

A box-like cover 6 has one of four sides of the opening thereof connected with a fourth side of the base 2 and the base 2, the guiding plate 3, the dynamic cutter 4 and the static cutter 5 are received in a hollow interior 61 of the cover 6. A second connection plate 62 is connected to the cover 6 and has second connection pieces 63 which are connected with the first connection pieces 53.

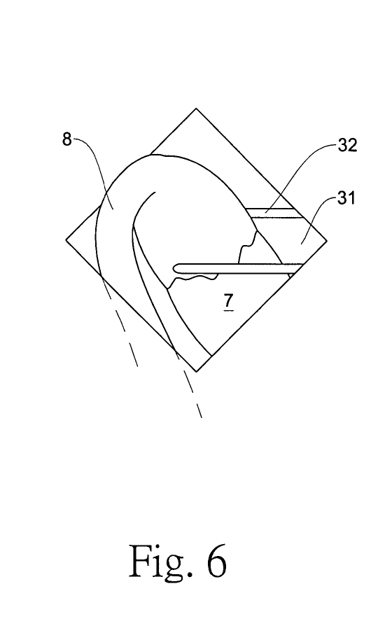

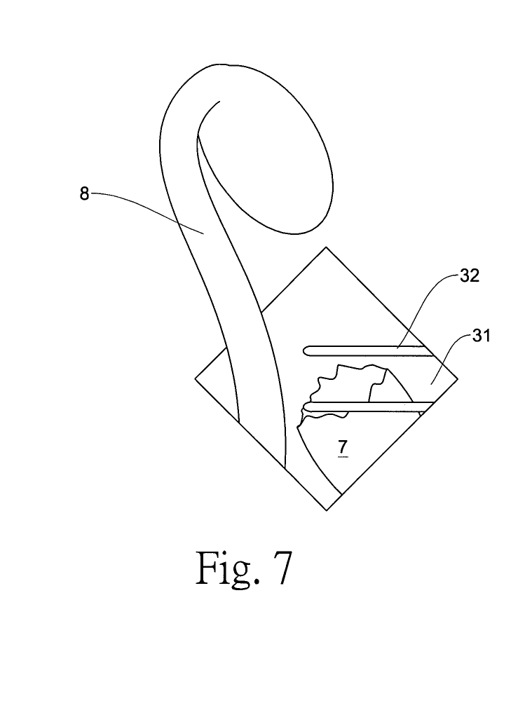

As shown in FIGS. 6 and 7, the seeds grow in the support member 23 and the skins of the seeds is restricted by the skin filters 32 so that the direction that the sprouts 8 grow in a desired direction. The pitch between the skin filters 32 is smaller than the width of the seed 7 and the skin filter 32 is made by elastic substance so that when the sprout 8 grows the skin of the seed 7 is removed or peeled by the skin filters 32. Therefore, the skin does not need an extra step to remove and the skin filters 32 also support the sprout 8.

The device and the sprouts 8 can be transported and sold to the customer directly without packing material.

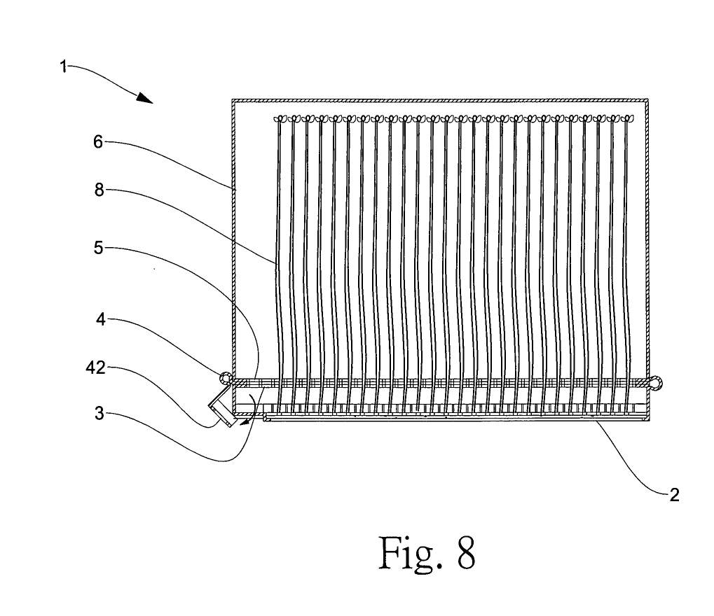

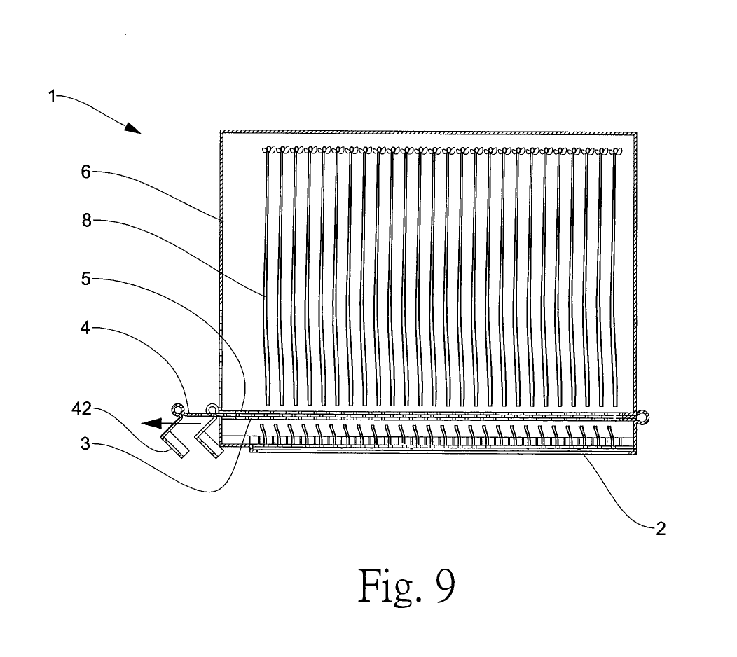

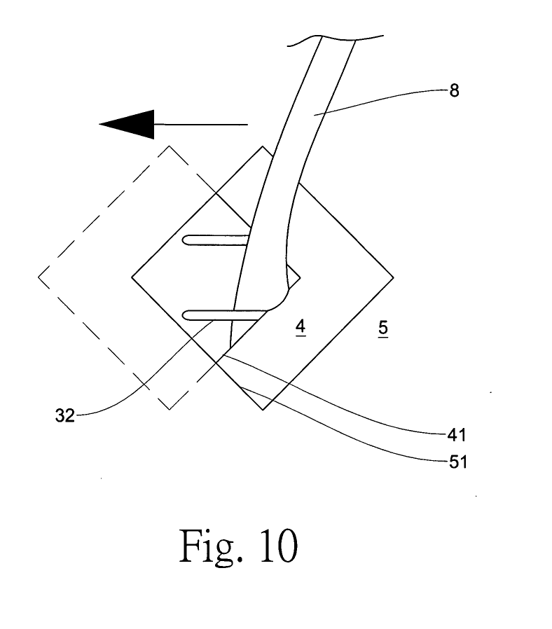

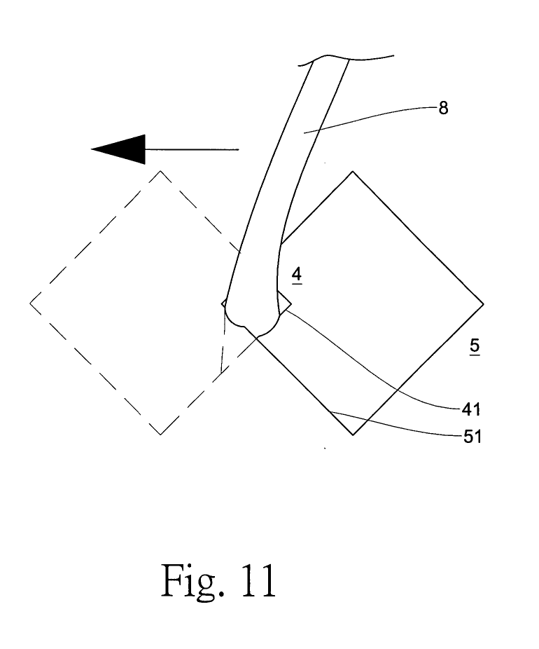

Referring to FIGS. 8 to 11, when the customers want to use the sprouts 8, the sprouts 8 are to be removed from the device 1, the user simply breaks the braking line 43 defined between the base 2 and the dynamic cutter 4, and pulls the dynamic cutter 4 by pulling the handle 42 at an end of the dynamic cutter 4, the sprouts 8 are located between the insides defining the cutting notches 41 and the shear edges 51, so that when moving the dynamic cutter 4, the sprouts 8 are cut by the inside of the cutting notches 41. This allows the user to cut the roots from the sprouts 8 and the sprout can be put into packages without too much extra steps.

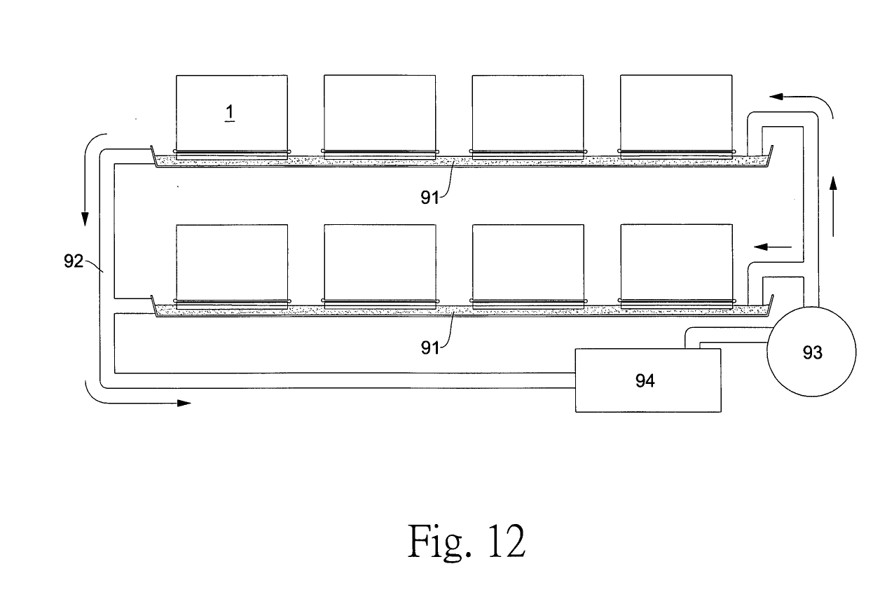

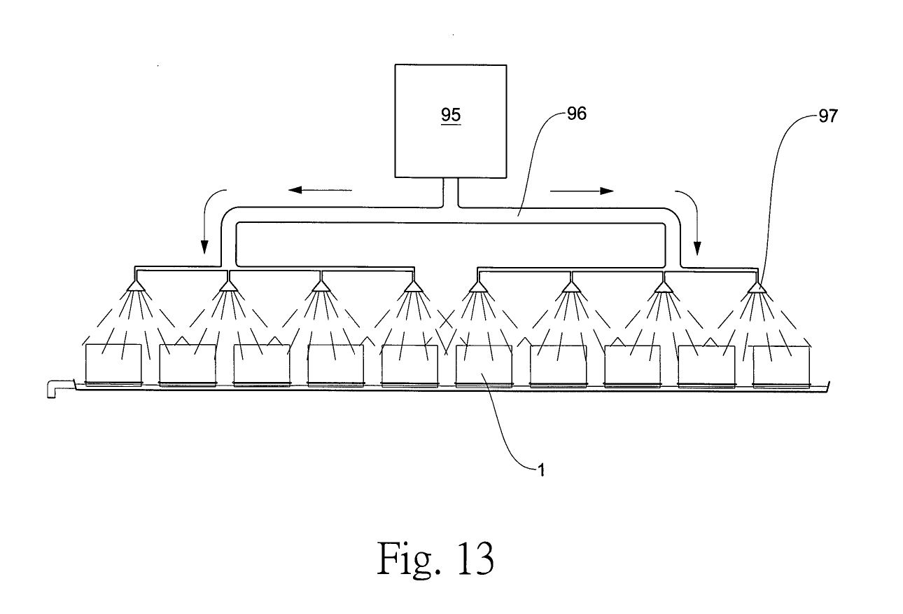

As shown in FIG. 12, multiple devices 1 can be arranged on a hydroponic bed 91 in a first arrangement wherein pipes 92 are connected with a pump 93 to pump and circulate nutrients from a tank 94. As shown in FIG. 13, a second arrangement is disclosed wherein the tank 95 for receiving nutrients has pipes 96 connected thereto and the nutrients can be fed to the seeds 7 by nozzles 97.

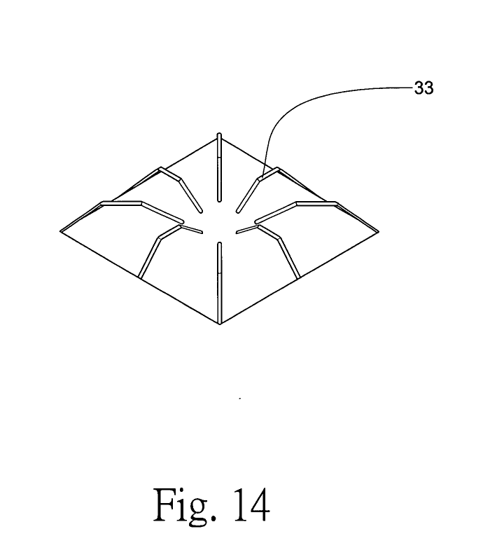

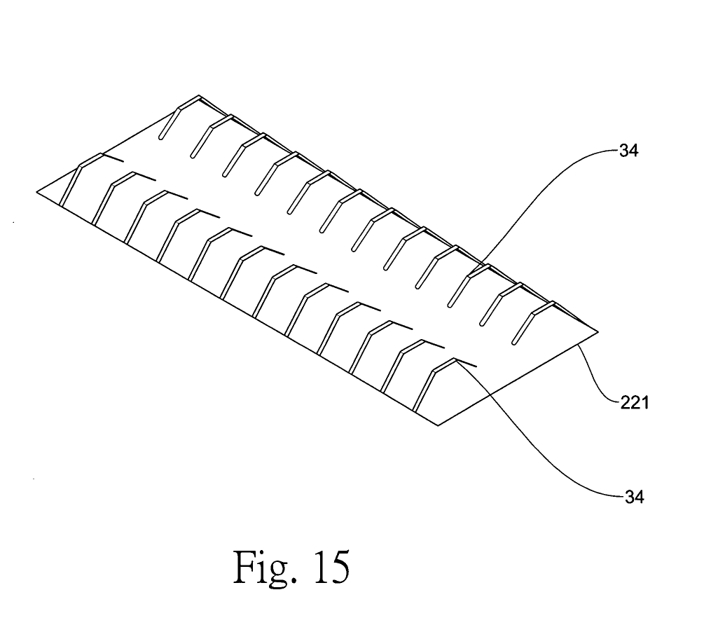

As shown in FIG. 14, the skin filters 33 can be made to extend inward toward a common center from a periphery of each of the recesses 31. FIG. 15 shows that the lattices 221 can be elongate slots and the skin filters 34 have rough surfaces and located on two sides of the elongate slots. The width, pitch, curvature, and quantity to the skin filters can be set according to the types of the seeds. If the seeds germination percentage is not good, multiple lattices are provided then the elongate slots of the lattices 221 are suitable to be used. On the contrary, if the seeds of the plants are easily to grow successfully, then the lattices 221 shown in FIG. 1 are suitable to be used.

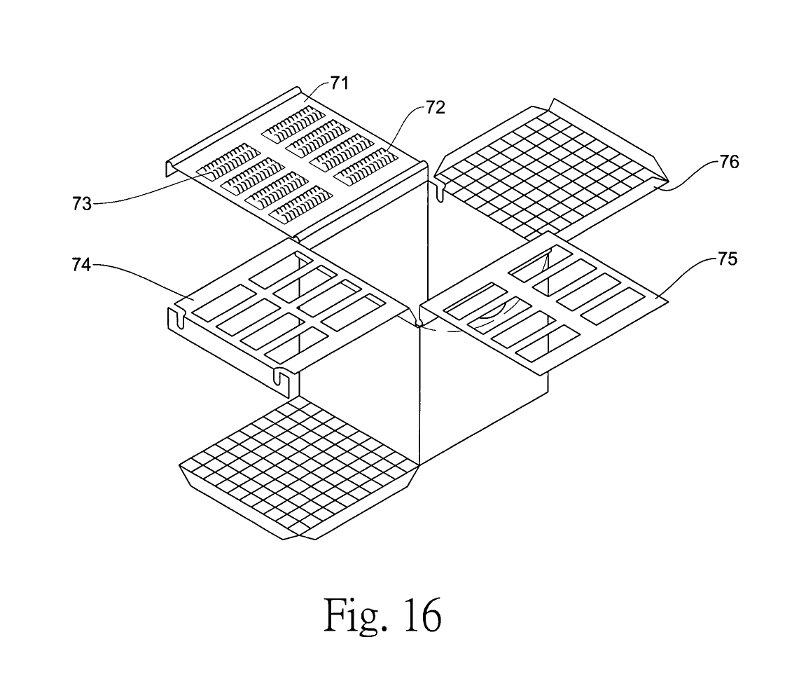

FIG. 16 shows another embodiment of the device wherein the base 71 includes elongate lattices 72 and skin filters 73 are located on two sides of the elongate lattices 72. The dynamic cutter 75, the static cutter 74, the base 71 and the nutrient pad are put in the cover and a bottom 76 is pivoted to seal the cover. The cover is then put up-side-down and the seeds can be received in the spaces within the elongate lattices 72.

While we have shown and described the embodiment in accordance with the present invention, it should be clear to those skilled in the art that further embodiments may be made without departing from the scope of the present invention.

What is claimed is:

1. A farming device, comprising:
a base having crosswise rails so as to define a plurality of lattices between the rails, each of the lattices having a support member located therebeneath and each support member having openings, a nutrient pad located beneath the support members;
a guiding plate located on the base and having a plurality of recesses which are located corresponding to the lattices;
a dynamic cutter movably located on the guiding plate and having a plurality of cutting notches which are located corresponding to the recesses;
a static cutter located on the dynamic cutter and having a plurality of shear edges which are located corresponding to the cutting notches, and
a cover having a hollow interior in which the base, the guiding plate, the dynamic cutter and the static cutter are received.

2. The device as claimed in claim 1, wherein each of the recesses has a plurality of skin filters located at a pitch therebetween.

3. The device as claimed in claim 1, wherein the recesses, the cutting notches and the shear edges are rectangle-shaped.

4. The device as claimed in claim 1, wherein a first connection plate is located between the base and the static cutter, the first connection plate includes a plurality of connection pieces, a second connection plate is connected to the cover and has second connection pieces which are connected with the first connection pieces.

5. The device as claimed in claim 1, wherein the dynamic cutter includes a handle at an end thereof and a braking line defined between the base and the dynamic cutter.

6. The device as claimed in claim 1, wherein the lattices are elongate slots.

7. The device as claimed in claim 2, wherein the skin filters extend inward toward a common center from a periphery of each of the recesses.

8. The device as claimed in claim 7, wherein the skin filters have rough surfaces.

9. The device as claimed in claim 1, wherein the the width, pitch, curvature, quantity to the skin filters can be set according to the types of the seeds.
